(19) United States
(12) Patent Application Publication
(10) Pub. No.: US 2014/0340999 A1
(43) Pub. Date: Nov. 20, 2014

(54) MEDICATION REMINDER METHOD AND SYSTEM

(71) Applicants: HON HAI PRECISION INDUSTRY CO., LTD., New Taipei (TW); HONG FU JIN PRECISION INDUSTRY (ShenZhen) CO., LTD., Shenzen (CN)

(72) Inventors: YA-BEI ZHANG, Shenzhen (CN); WEN-YI WU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/085,970

(22) Filed: Nov. 21, 2013

(30) Foreign Application Priority Data
May 16, 2013 (CN) 2013101807032

(51) Int. Cl. G04F 1/00; G06F 19/00

(52) U.S. Cl. CPC G04F 1/005; G06F 19/3456
USPC 368/109

(57) ABSTRACT

A medication reminder method and system are provided. A carrier device acquires medication information of a medication from a medication information server via a network. The medication information includes a pre-determined time interval prescribed for the medication. The carrier device activates an alarm device to emit an alarm signal to remind a user to take the medication on expiry of the pre-determined time interval.

### REFERENCE TO RELATED APPLICATIONS

This application claims all benefits accruing under 35 U.S.C. §119 from China Patent Application No. 201310180703.2, filed on May 16, 2013 in the State Intellectual Property Office of China. The contents of the China Application are hereby incorporated by reference.

### BACKGROUND

1. Technical Field

The disclosure generally relates to health-care technologies, and particularly relates to medication reminder methods and systems.

2. Description of Related Art

It is well known that patients who are prescribed medications, or who take over the counter (OTC) medications, should take such medications at pre-determined time intervals as prescribed by the doctor or as indicated on the OTC medication package. If the patient ignores these instructions such as taking the prescribed medication too often or too seldom, this may result in serious adverse effects such as overdose risks or reduction in the concentration of medication in the body. Many patients miss dosages because they are distracted or forgetful. This is particularly true for elderly patients. Although patients may set an alarm clock or the like at a prescribed medication time interval, they may still set the incorrect time interval or forget to re-set the alarm after taking a medication.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of an electronic device suitable for implementing a medication reminder system.

FIG. 2 is a block diagram of one embodiment of the medication reminder system.

FIG. 3 is a schematic view of an example of the electronic device in communication with a medication information server and a medication tracking server.

FIG. 4 is a flowchart of one embodiment of a medication reminder method implemented the electronic device of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

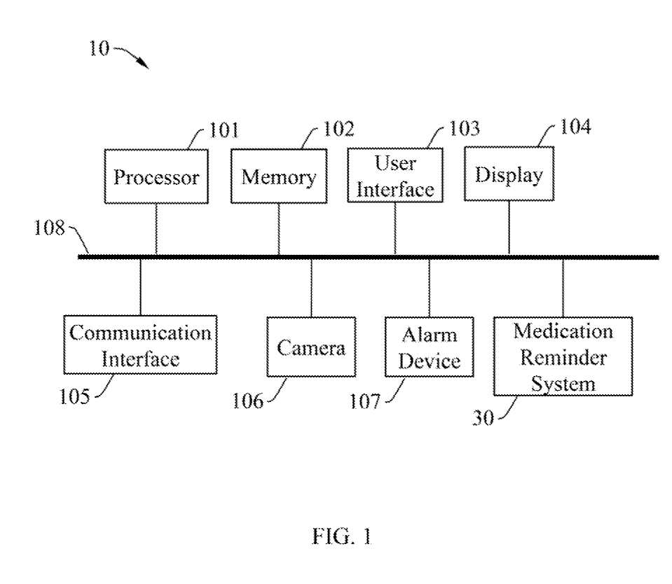

FIG. 1 is a block diagram of an exemplary embodiment of an electronic device 10 suitable for implementing a medication reminder system 30. The illustrated embodiment of the electronic device i0 includes, without limitation: at least one processor 101, a suitable amount of memory 102, a user interface 103, a display 104, a communication interface 105, a camera 106, and an alarm device 106. Of course, the electronic device 10 may include additional elements, components, modules, and be functionality configured to support various features that are unrelated to the subject matter described here. In practice, the elements of the electronic device 10 may be coupled together via a bus or any suitable interconnection architecture 108.

The processor 101 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here.

The memory 102 may be realized as RAM memory, flash memory, EPROM memory, EEPROM memory, registers, a hard disk, a removable disk, a CD-ROM, or any other form of storage medium known in the art. The memory 102 is coupled to the processor 101 such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The user interface 103 may include or cooperate with various features to allow a user to interact with the electronic device 10. Accordingly, the user interface 103 may include various human-to-machine interfaces, e.g., a keypad, keys, a keyboard, buttons, switches, knobs, a touchpad, a joystick, a pointing device, a virtual writing tablet, a touch screen, or any device, component, or function that enables the user to select options, input information, or otherwise control the operation of the electronic device 10. In various embodiments, the user interface 103 may include one or more graphical user interface (GUI) control elements that enable a user to manipulate or otherwise interact with an application via the display 104.

The display 104 is suitably configured to enable the electronic device 10 to render and display various screens, GUIs, GUI control elements, drop down menus, auto-fill fields, text entry fields, message fields, or the like. Of course, the display 104 may also be utilized for the display of other information during the operation of the electronic device 10, as is well understood.

The communication interface 105 may provide connectivity channels for receiving and transmitting information and/or for connecting to other electronic devices. The communication interface 105 may represent, for example, a network interface card (NIC) or a network controller. The communication interface 105 may include a local area network (LAN) interface for connecting to a wired Ethernet-based network and/or a wireless LAN, such as an IEEE 802.11x wireless network.

The communication interface 105 also may include a wide area network (WAN) interface that permits connection to the Internet via a cellular data network, such as the Enhanced Data rates for GMS Evolution (EDGE) network or a 3G or 4G network. Further, the communication interface 105 may include a personal area network (PAN) interface for connecting to a BLUETOOTH® network, an IEE 802.15.4 (Zig-Bee) network, or an ultra-wideband network (UWB). The communication interface 105 may include any number and combination of network interfaces. The communication interface 105 can employ one or more protocols, such as the High-Speed Downlink Packet Access (HSDPA) protocol, for rapidly downloading data over an Internet Protocol (IP) network.

The camera 106 may record images. The images may be photographs or moving images such as videos or movies. The camera 105 may be used to scan a code bar on a container of a medication.

The alarm device 107 may produce an alarm signal. The alarm device 107 may be a visual alarm device such as a light emitting diode (LED), an audible alarm device, a vibrator, or other types of alarm device. In alternative embodiments, more than one alarm device 107 may be provided, such as both LED and audible alarm devices.

The medication reminder system 30 may be implemented using software, firmware, or other computer programming technologies.

The electronic device 10 may be realized in any common form factor including, without limitation: a desktop computer, a mobile computer (e.g., a tablet computer, a laptop computer, or a netbook computer), a smartphone, a video game device, a digital media player, or the like.

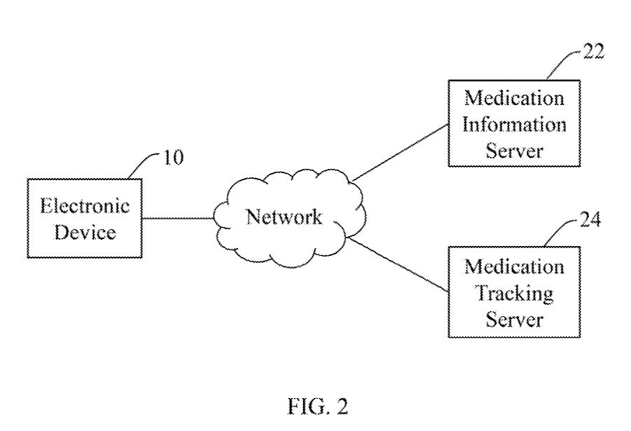

FIG. 2 shows that the electronic device 10 is connected to a medication information server 22 and a medication tracking server 24 via an IP network. The electronic device 10 may acquire medication information regarding a medication from the medication information server 22 and uploads medication taken logs to the medication tracking server 24.

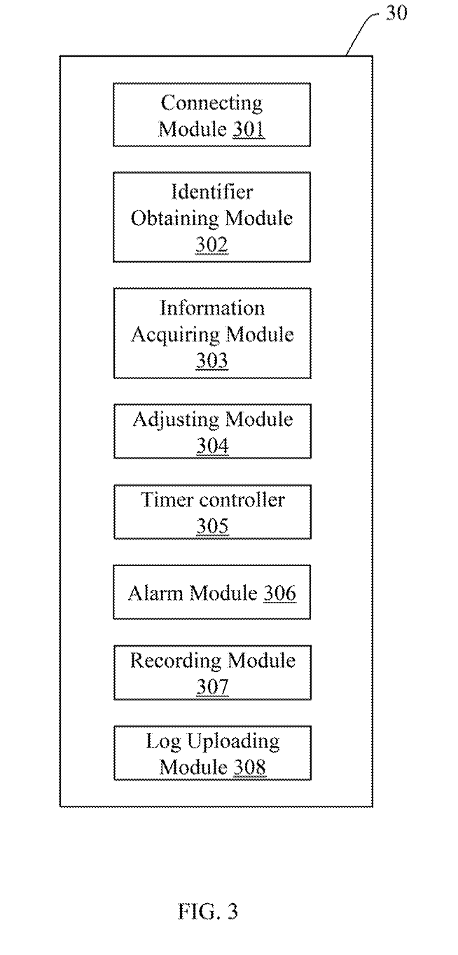

FIG. 3 shows a block diagram of an embodiment of the medication reminder system 30 implemented in the electronic device 10. The medication reminder system 30 includes a space dividing module 201, a delay calculating module 202, a user detecting module 203, a user selecting module 204, an imaginary cubic area determining module 205, a wave beam calculating module 206, a voice recording module 207, a voice monitoring module 208, and a wave beam recalculating module 209.

The connecting module 301 may establish a communication connection with the medication information server 22 via the IP network.

The identifier obtaining module 302 may instruct the camera 106 to scan a bar code on a container of a medication and read a medication identifier regarding the medication from the bar code.

The information acquiring module 303 may send a query request with the medication identifier to the medication information server 22 and receive medication information regarding the medication from the medication information server 22. The medication information may include information regarding a pre-determined time interval and a pre-determined dosage prescribed for the medication.

The adjusting module 304 may instruct the user interface 103 to allow the user to adjust the pre-determined time interval and the pre-determined dosage.

The timer controller 305 may start a timer associated with the pre-determined time interval.

The alarm module 306 may activate the alarm device 107 to emit an alarm signal to remind a user to take the medication on expiry of the pre-determined time interval.

The recoding module 307 may instruct the user interface 103 to receive a confirmation feedback from the user and generate a log recording that the user has taken the medication in response to the confirmation feedback. After that, the recording module 308 may restart the timer.

The log uploading module 308 may establish a communication connection with the medication tracking server 24 via the IP network and upload the log to a medication history repository associated with the user in the medication tracking server 24.

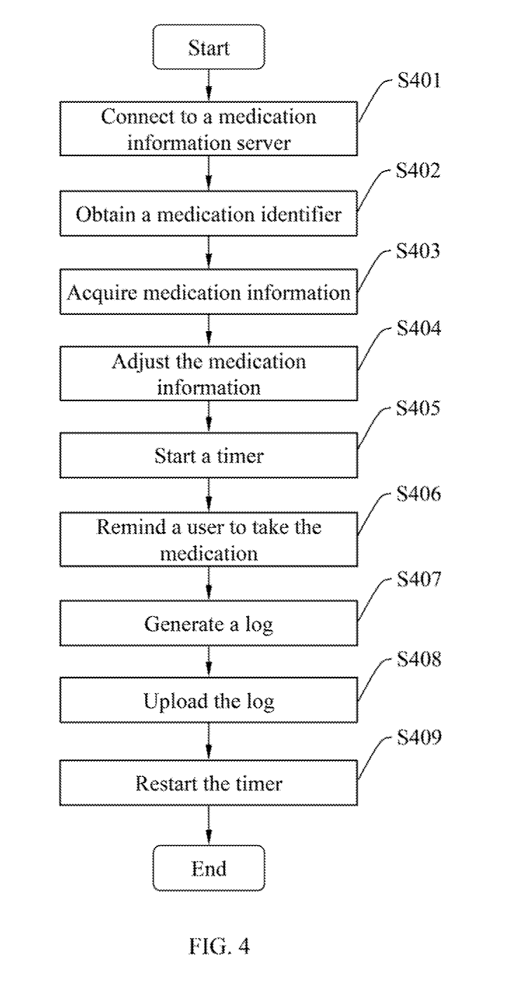

FIG. 4 shows a flowchart of one embodiment of a medication reminder method implemented by the electronic device 10. The method includes the following steps.

In step S401, the connecting module 301 establishes a communication connection with the medication information server 22 via the IP network.

In step S402, the identifier obtaining module 302 instructs the camera 106 to scan a bar code on a container of a medication and reads a medication identifier regarding the medication from the bar code.

In step S403, the information acquiring module 303 sends a query request with the medication identifier to the medication information server 22 and receives medication information regarding the medication from the medication information server 22. The medication information includes information regarding a pre-determined time interval and a pre-determined dosage prescribed for the medication.

In step S404, the adjusting module 304 instructs the user interface 103 to allow the user to adjust the pre-determined time interval and the pre-determined dosage

In step S405, the timer controller 305 starts a timer associated with the pre-determined time interval.

In step S406, the alarm module 306 activates the alarm device 107 to emit an alarm signal to remind a user to take the medication on expiry of the pre-determined time interval.

In step S407, the recoding module 307 instructs the user interface 103 to receive a confirmation feedback from the user and generates a log recording that the user has taken the medication in response to the confirmation feedback.

In step S408, the log uploading module 308 establishes a communication connection with the medication tracking server 24 via the IP network and uploads the log to a medication history repository associated with the user in the medication tracking server 24.

In step S409, the timer controller 305 restarts the timer after the log has been uploaded to the medication history repository.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A medication reminder method, comprising:
connecting to a medication information server via an Internet Protocol (IP) network;
acquiring medication information of a medication from the medication information server, the medication information comprising a time interval prescribed for the medication;
starting a timer associated with the time interval; and
activating an alarm device to emit a reminder when the time interval expires.

2. The medication reminder method of claim 1, further comprising:
obtaining a medication identifier of the medication; and
transmitting a query request with the medication identifier to the medication information server; and
receiving the medication information of the medication from the medication information server.

3. The medication reminder method of claim 2, wherein the obtaining the medication identifier comprises:
scanning a bar code on a container of the medication; and
reading the medication identifier of the medication from the bar code.

4. The medication reminder method of claim 1, wherein the medication information further comprises a dosage prescribed for the medication, the method further comprises:
displaying the dosage on a display when the interval expires.

5. The medication reminder method of claim 1, further comprising:
providing a user interface to allow adjusting the time interval.

6. The medication reminder method of claim 1, further comprising:
providing a user interface to receive a confirmation feedback; and
generating a log recording that the medication has been taken in response to the confirmation feedback.

7. The medication reminder method of claim 6, further comprising:
connecting to a medication tracking server via an IP network;
uploading the log to a medication history repository associated with a user in the medication tracking server.

8. The medication reminder method of claim 7, further comprising restarting the timer after the log has been uploaded to the medication history repository.

9. An electronic device, comprising:
a memory;
at least one processor coupled to the memory;
one or more programs being stored in the memory and executable by the at least one processor, the one or more programs comprising:
a connecting module configured for connecting to a medication information server via an Internet Protocol (IP) network;
an information acquiring module configured for acquiring medication information of a medication from the medication information server, the medication information comprising a time interval prescribed for the medication;
a timer controller configured for starting a timer associated with the time interval; and
an alarm module configured for activating an alarm device to emit a reminder when the time interval expires.

10. The electronic device of claim 9, further comprising an identifier obtaining module configured for obtaining a medication identifier of the medication, wherein the information acquiring module is configured for transmitting a query request with the medication identifier to the medication information server and receiving the medication information of the medication from the medication information server.

11. The electronic device of claim 10, wherein the identifier obtaining module is configured for scanning a bar code on a container of the medication and reading the medication identifier from the bar code.

12. The electronic device of claim 9, wherein the medication information further comprises a dosage prescribed for the medication, the electronic device further comprises a dosage display module configured for displaying the dosage on a display when the time interval expires.

13. The electronic device of claim 9, further comprising an adjusting module configured for providing a user interface to allow adjusting the time interval.

14. The electronic device of claim 9, further comprising a recoding module configured for providing a user interface to receive a confirmation feedback and generating a log recording that the medication has been taken in response to the confirmation feedback.

15. The electronic device of claim 14, further comprising a log uploading module configured for connecting to a medication tracking server via an IP network, uploading the log to a medication history repository associated with a user in the medication tracking server.

16. The electronic device of claim 15, wherein the timer controller is further configured for restarting the timer after the log has been uploaded to the medication history repository.
